(19) United States
(12) Patent Application Publication
(10) Pub. No.: US 2016/0326065 A1
(43) Pub. Date: Nov. 10, 2016

(54) MIXED-METALLIC CRYSTALLINE ORTHOPHOSPHATES FOR THE TEMPORALLY CONTROLLED RELEASE OF TRACE ELEMENTS IN THE RHIZODERMAL AND EPIDERMAL AREAS OF PLANTS

(71) Applicant: CHEMISCHE FABRIK BUDENHEIM KG, Budenheim (DE)

(72) Inventors: Albertus WISSING, Liederbach am Taunus (DE); Christian GRAF, Mainz (DE); Daniel BUCHHOLD, Ingelheim (DE); Kilian SCHWARZ, Mainz (DE); Michael RAPPHAHN, Eschborn (DE)

(21) Appl. No.: 15/109,561

(22) PCT Filed: Dec. 22, 2014
(86) PCT No.: PCT/EP2014/078946

§ 371 Date: Jul. 1, 2016

(30) Foreign Application Priority Data
Jan. 2, 2014 (DE) 10 2014 100 026.9

(51) Int. Cl. C05B 7/00; C01B 25/45

(52) U.S. Cl. CPC C05B 7/00; C01B 25/45; C01B 25/451

(57) ABSTRACT

A nutrient composition improved over the state of the art and which releases the nutrients contained therein in a time-controlled manner in the rhizodermal and epidermal region of the plants. The nutrient composition for plants contains at least one mixed-metallic crystalline orthophosphate of the type [Tₐ(M1 M2 M3 . . . Mx)_{b}(PO₄)_{c}.nH₂O], wherein
T is selected from NH₄, K or CH₄N₂O,
M1, M2, M3 . . . Mx are metals selected from Mg, Ca, Mn, Fe, Co, Ni, Cu and Zn,
a=0 or 1, wherein
   b=3 when a=0 and b=1 when a=1 and wherein
   c=2 when a=0 and c=1 when a=1 and wherein
0<n<9,
   wherein the mixed-metallic crystalline orthophosphate contains at least two different metals M1, M2, M3 . . . Mx, with the proviso that at least one of said at least two different metals is selected from Mn, Mg and Ca, wherein the total proportion of Mn, Mg and/or Ca in total is in the region of 0.5 to 90 mol-% with respect to the total amount of all metals contained in the mixed-metallic crystalline orthophosphate.

Mixed-metallic crystalline orthophosphates for the temporally controlled release of trace elements in the rhizodermal and epidermal areas of plants

The present invention concerns an enhanced efficiency nutrient composition for time-controlled release of trace elements in the rhizodermal and epidermal region of plants. In addition the present invention concerns the use of such a nutrient composition in a method of fertilising plants, which involves time-controlled release of trace elements in the rhizodermal and epidermal region of plants.

### 1. BACKGROUND OF THE INVENTION

To ensure healthy growth plants must take various nutrients from the ground in which they grow. However many grounds suffer from a deficit of certain elements or they are present in a form which is not available to plants.

Enhanced efficiency fertilisers have certain formulations, contain special additives or have particular physical properties which have the potential to enhance the nutrient uptake by plants. In the ideal case nutrient delivery which occurs linearly to sigmoidally should take place, with the aim of synchronising the need in the course of plant growth and to protect the nutrient substances from reactions in the ground or in the case of leaf application on the plant surface, which can reduce the availability for plants.

The feed of fertilisers can be effected by way of the ground or by application to the above-ground parts of the plants. In that way nutrients like for example trace elements can be made available in the rhizodermal or epidermal region of plants. The term rhizodermal refers here to the outer cell tissue of the plant roots, the rhizodermis. In contrast the term epidermal refers here to the outer cell tissue of the above-ground parts of the plant, the epidermis.

2. STATE OF THE ART

The majority of enhanced efficiency fertilisers naturally have a high level of water solubility. Release of the nutrients contained therein is substantially controlled by the water solubility of the formulation surrounding them. In many types of product the fertiliser particles are embedded in a given carrier matrix like for example a mixture of molten waxes, surfactants and polyethylene glycols. With that approach however a large amount (up to 40%) of carrier material is required to achieve the desired depot effect.

In the case of fertilisers encased with polymer coatings the release of nutrient substances is heavily dependent on the quality of the coating. If there are cracks in the coating granular materials upon contact with water can immediately release up to a third or more of the nutrient substances and on the other hand in part a third of the nutrient substances are released, only long after they are required by the plant. Those release patterns differ considerably from the desired linear to sigmoidal form of nutrient provision. A further detrimental aspect of the polymer-coated fertilisers is that the use thereof can lead to an unwanted accumulation of plastic residues in the treated grounds.

Alternative enhanced efficiency fertilisers are metal ammonium phosphates or metal potassium phosphates and partially acidulated phosphates rock (PAPR) which considered in themselves can be referred to as inorganic compounds which are difficult to dissolve. A number of metal ammonium phosphates are valued as fertilisers which are to be used for the ground, for example U.S. Pat. No. 3,125,411 or U.S. Pat. No. 3,174,844. The probably best-known product of that kind is magnesium ammonium phosphate as a hexahydrate (inter alia a constituent of “guano”).

U.S. Pat. No. 3,574,591 describes slowly dissolving ammonium potassium metal phosphates with a straight or branched chain structure. US No 2010/0024026 describes trace element fertilisers which are practically insoluble in water in the form of polymerised metal phosphates, which pass into solution in an acidulated medium.

### 3. OBJECT OF THE INVENTION

The object of the present invention is to provide a nutrient composition which is improved over the state of the art and which releases the nutrients contained therein in time-controlled manner when the nutrient composition is made available in the rhizodermal and epidermal region of the plants.

### 4. ATTAINMENT OF THE OBJECT OF THE INVENTION

According to the invention therefore there is proposed a nutrient composition for plants which contains at least one mixed-metallic crystalline orthophosphate of the type [Tₐ(M1 M2 M3 . . . Mx)_{b}(PO₄)_{c}.nH₂O], wherein T is selected from NH₄, K or CH₄N₂O, and M1, M2, M3 . . . Mx are metals selected from Mg, Ca, Mn, Fe, Co, Ni, Cu and Zn, wherein the mixed-metallic crystalline orthophosphate contains at least two different metals, with the proviso that at least one of said at least two different metals M1, M2, M3 . . . Mx is selected from Mn, Mg and Ca, wherein the total proportion of Mn, Mg and/or Ca in total is in the region of 0.5 to 90 mol-% with respect to the total amount of all metals contained in the mixed-metallic crystalline orthophosphate. In the cases in which a=0 b=3 and c=2. In the cases in which a=1 b=1 and c=1. In addition the rule 0≦n≦9 applies.

### 5. ADVANTAGES OF THE INVENTION

In many grounds there are in themselves sufficient trace elements present, but they are frequently not in bio-available form. The reason for this is generally the low level of solubility of individual ions like for example those of iron, which occurs primarily as Fe(III)-oxide and -hydroxide which are extraordinarily difficult to dissolve. The equilibrium concentration of the iron which is present freely in the ground matrix in the case of a neutral pH-value is at about 10⁻¹⁷ M and is thus far beneath the necessary requirement of 10⁻⁶ to 10⁻⁵ M of cultivated plants. To overcome those barriers of the solubility problem plants have developed various strategies, in particular for improved cation uptake.

One strategy on the part of the plants aims at reducing the pH-value in the rhizodermal region by means of the mechanism of the “proton pump” or by the directed delivery of organic acids (for example malic and citric acid) by the plant roots. In that way the pH-value in the rhizospheric root region can be reduced by up to 2 pH-gradients and the solubility and thus availability of metal ions is markedly increased by the acidulation and thus nutrient uptake is improved.

A second possibility in terms of nutrient uptake, in particular also of trace elements, lies in the absorption of ionic elements by way of the epidermal leaf surface into the plant parenchyma. In the case of low pH-value nutrient crystals can gradually pass into solution on the leaf surface and can thus be converted into a form in which uptake can occur. The pH-value change into the acid range is effected for example by CO₂ which upon dissolution in water (films) on the leaf surface forms carbonic acid (H₂CO₃) and in addition by substances having an acid action on the leaf surface (from the deposition of substances from the atmosphere) like for example ammonium sulphate, ammonium hydrogen sulphate or “acid rain”.

According to the invention therefore there is proposed a nutrient composition for plants, which offers trace elements essential for plants in an exchangeable or extractable form, wherein the nutrient composition has defined solubility properties. The nutrient compositions according to the invention are distinguished in particular by a low level of water solubility with at the same time a high level of solubility in the acid pH-range. In that way, by virtue of the use of nutrient composition according to the invention, the nutrient availability is not controlled by hydrolysis or diffusion rates, but can be actively induced by the plants being treated.

The plants treated with nutrient compositions according to the invention can specifically mobilise nutrients from the nutrient composition by root excretions like for example organic acids (for example citric acid) or by the active reduction of the pH-value in the rhizospheric root region in another way (see above). That represents not only an improvement in availability over time but with an optimum adjustment of the ratio of water and acid solubility also leads to a reduction in the uncontrolled delivery of nutrients to the environment. Enhanced efficiency fertilisers are thus afforded with a depot function, which ensure time-controlled nutrient release in the region of the rhizosphere of the plants being treated, without causing excessive nutrient transfer into the environment.

All this is achieved by virtue of the fact that the nutrient compositions proposed according to the invention contain mixed-metallic orthophosphates in crystalline form, wherein at least two different metals are contained in the crystal structure of the orthophosphates, with the proviso that at least one of said at least two different metals is selected from Mn, Mg and Ca, and with the further proviso that the total proportion of Mn, Mg and/or Ca is in total in the region of 0.5 to 90 mol-% with respect to the total amount of all metals contained in the mixed-metallic crystalline orthophosphate.

The crystalline mixed-metallic orthophosphates of the present invention are salts of phosphoric acid which in contrast to polyphosphates occur in non-condensed form. The crystalline mixed-metallic orthophosphates of the present invention are distinguished by a regular and continuous arrangement of the orthophosphate molecules and the possibly present water of crystalisation in a crystal structure which can be detected by the reflections occurring in X-ray diffraction analysis (see FIG. 8).

The inventors' experiments as set forth in detail hereinafter have shown that, due to the presence of Mn, Mg and/or Ca in the crystal structure, the water and acid solubility of the mixed-metallic crystalline orthophosphates can be individually adjusted.

A further advantage which arises out of the crystal structure of the mixed-metallic crystalline orthophosphates according to the invention is that the metals enclosed in the crystal lattice are protected from oxidative influences. As plants for nutrition physiological reasons preferably take up bivalent metallic ions the integrated trace elements in the mixed-metallic crystalline orthophosphates of the present invention preferably occur in the bivalent uptake form preferred by the plant (Fe²⁺, Mn²⁺, Cu²⁺, Zn²⁺ or Mg²⁺). It is precisely in those cases therefore that the protection from oxidative influences by enclosure of the metals in a crystal lattice is of particular advantage.

### 6. SPECIFIC EMBODIMENTS OF THE INVENTION

The advantages of the present invention are attained by the claimed mixed-metallic crystalline orthophosphates in which the total proportion of Mn, Mg and/or Ca in total is in the region of 0.5 to 90 mol-% with respect to the total amount of all metals contained in the mixed-metallic crystalline orthophosphate.

In an embodiment of the invention the total proportion of Mn, Mg and/or Ca is at least 5 mol-%. In further embodiments of the invention the total proportion of Mn, Mg and/or Ca is at least 10 mol-%, at least 15 mol-%, at least 20 mol-% or at least 25 mol-%. The upper limit value of the total proportion of Mn, Mg and/or Ca in these embodiments is optionally up to 90 mol-%, 85 mol-%, up to 80 mol-%, up to 75 mol-% or up to 70 mol-%.

In certain embodiments, within the specified total proportion of Mn, Mg and/or Ca, the molar ratio of Mg or Ca or the total of Mg and Ca on the one hand to Mn on the other hand is in a range of 0.5:1 to 10:1. In further embodiments of the invention within the specified total proportion of Mn, Mg and/or Ca the molar ratio of the Mg or Ca or the total of Mg and Ca on the one hand to Mn on the other hand is at least 1:1, at least 2:1 or at least 5:1 and respectively up to 10:1.

An embodiment of the nutrient composition according to the invention is characterised in that within a period of up to 50 hours at most 10 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer.

In a specific embodiment the total proportion of Mn, Mg and/or Ca is so selected that within a period of up to 50 hours at most 5 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer. In a further specific embodiment the total proportion of Mn, Mg and/or Ca is so selected that within a period of up to 50 hours at most 2.5 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer.

An embodiment of the nutrient composition according to the invention is characterised in that within a period of up to 100 hours at most 20 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer.

In a specific embodiment the total proportion of Mn, Mg and/or Ca is so selected that within a period of up to 100 hours at most 10 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer. In a further specific embodiment the total proportion of Mn, Mg and/or Ca is so selected that within a period of up to 50 hours at most 5 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer.

An embodiment of the nutrient composition according to the invention is characterised in that within a period of up to 50 hours at least 25 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer.

In a specific embodiment the total proportion of Mn, Mg and/or Ca is so selected that within a period of up to 50 hours at least 35 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer. In a further specific embodiment the total proportion of Mn, Mg and/or Ca is so selected that within a period of up to 50 hours at least 45 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer.

An embodiment of the nutrient composition according to the invention is characterised in that within a period of up to 100 hours at least 35 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer.

In a specific embodiment the total proportion of Mn, Mg and/or Ca is so selected that within a period of up to 100 hours at least 45 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer. In a further specific embodiment the total proportion of Mn, Mg and/or Ca is so selected that within a period of up to 100 hours at least 55 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer.

An embodiment of the nutrient composition according to the invention is characterised in that within a period of up to 50 hours at least 75 wt-% of each of the metals contained in the mixed-metallic crystalline orthophosphate pass into solution if 0.03 g of the mixed-metallic crystalline orthophosphate is continuously circulated in 30 ml of 5 mmol citric acid solution at 25° C. on a tumbler mixer.

In a specific embodiment the total proportion of Mn, Mg and/or Ca is so selected that within a period of up to 50 hours at least 85 wt-% of each of the metals contained in the mixed-metallic crystalline orthophosphate pass into solution if 0.03 g of the mixed-metallic crystalline orthophosphate is continuously circulated in 30 ml of 5 mmol citric acid solution at 25° C. on a tumbler mixer. In a further specific embodiment the total proportion of Mn, Mg and/or Ca is so selected that within a period of up to 50 hours at least 95 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer.

An embodiment of the nutrient composition according to the invention is characterised in that the total proportion of Mn, Mg and/or Ca in total is in the region of 2.5 to 80 mol-%, preferably in the region of 5 to 75 mol-% with respect to the total amount of all metals contained in the mixed-metallic crystalline orthophosphate.

An embodiment of the nutrient composition according to the invention is characterised in that the at least one mixed-metallic crystalline orthophosphate is of the type [(M1 M2 M3 . . . Mx)₃(PO₄)₂.nH₂O], wherein M1, M2, M3 . . . Mx are selected from Mg, Ca, Mn, Fe, Co, Ni, Cu and Zn, and wherein 0≦n≦9.

An embodiment of the nutrient composition according to the invention is characterised in that the at least one mixed-metallic crystalline orthophosphate is of the type [T (M1 M2 M3 . . . Mx)(PO₄).nH₂O], wherein T is selected from NH₄, K or (NH₂)₂CO, wherein M1, M2, M3 . . . Mx are selected from Mg, Ca, Mn, Fe, Co, Ni, Cu and Zn, and wherein n≦1.

An embodiment of the nutrient composition according to the invention is characterised in that in addition to the at least one mixed-metallic crystalline orthophosphate the nutrient composition contains further additives which are selected from macronutrients, micronutrients, multi-nutrient fertilisers, organic fertilisers, plant enhancers, chelating and complexing substances or ground structure improving agents as well as peat cultivation substrates, peat-free earths and standard soils or substrates with peat and clay.

In the embodiments of the invention in which the nutrient composition according to the invention, in addition to the at least one mixed-metallic crystalline orthophosphate, contains further additives, the total proportion of mixed-metallic crystalline orthophosphate according to the invention contained in the nutrient composition is 5 to 90% by weight. In specific embodiments the total proportion of mixed-metallic crystalline orthophosphate according to the invention contained therein is at least 10 wt-%, at least 15 wt-%, at least 20 wt-% or at least 25 wt-%. In these embodiments the total proportion of mixed-metallic crystalline orthophosphate according to the invention contained therein is up to 70 wt-%, up to 75 wt-%, up to 80 wt-% or up to 85 wt-%.

An embodiment of the nutrient composition according to the invention is characterised in that the nutrient composition is in the form of a suspension, a powdered fertiliser, a granulated fertiliser, in the form of an enhanced efficiency fertiliser or in the form of a storage fertiliser with defined slow nutrient release (depot fertiliser).

The invention also concerns the use of a nutrient composition of the above-mentioned kind for the time-controlled release of Mg, Ca, Mn, Fe, Co, Ni, Cu and/or Zn in the rhizodermal and epidermal region of plants. As the inventors' experiments set forth in detail hereinafter have shown the water and acid solubility of the mixed-metallic crystalline orthophosphates can be individually adjusted by the selection of suitable proportions of Mn, Mg and/or Ca in the crystal structure.

The present invention therefore also includes a method of fertilising plants, wherein in the method a nutrient composition according to one of the preceding claims is made available in the rhizodermal and epidermal region of the plants, wherein the water and acid solubility of the mixed-metallic crystalline orthophosphates can be individually adjusted by the selection of suitable proportions of Mn, Mg and/or Ca in the crystal structure.

An embodiment of the method according to the invention is characterised in that in the method the solubility of the at least one mixed-metallic crystalline orthophosphate contained in the nutrient composition in water, in 1 mmol citric acid solution and/or in 5 mmol citric acid solution is so selected that the metals Mg, Ca, Mn, Fe, Co, Ni, Cu and/or Zn contained in the at least one mixed-metallic crystalline orthophosphate are released in time-controlled manner in the amount required for the respective plant and the given conditions.

### 7. DESCRIPTION OF THE AREAS OF APPLICATION

The nutrient compositions according to the invention can be used as nutrient substances in all areas of plant nutrition, for example in agriculture, horticulture or forestry for nutrient feed in numerous plant crops. A preferred use of the metal-P-compounds according to the invention is use in combination with further macronutrients supplementing the nutrient composition like nitrogen, potassium and phosphate, with secondary nutrient substances like calcium, sulphate, magnesium and with supplementing micronutrients.

The nutrient compositions according to the invention can be used in multi-nutrient fertilisers known to the man skilled in the art in the field of agricultural chemistry, organic fertilisers or ground structure improving agents or for example also in the form of coatings or nutrient fillings of granulated fertiliser forms, by way of example in so-called controlled release formulations (CRF) and slow release formulations (SRF), generally enhanced efficiency fertilisers or storage fertilisers (depot fertilisers), including the conventional CULTAN application system (controlled uptake long term ammonium nutrition), with included nitrogen exclusively as ammonium or in modified form by way of example based on urea/ammonium sulphate as granular material or UAS or urea/ammonium/nitrate as granular material or UAN solution with defined slow nutrient release or in so-called condensed fertiliser forms.

The nutrient compositions according to the invention can be used as a nutrient substance in ground application, in leaf application and also for seed treatment. The nutrient compositions can be applied to the seed undiluted or preferably diluted. Use can be effected prior to sowing.

The products according to the invention can be used in particular in the area of watering cultivated plants (fertigation), which include for example systems for droplet watering, micro-irrigation or hydroponics. The product according to the invention can be integrated into systems which surround and support the plant roots. These can be containers, pots, trays, vessels or pressed systems (substrate and coir pellets, or blocks) of various materials like for example clay, peat (for example sphagnum white peat), coconut fibre, organic substrate, cellulose and plastic material, and also carrier systems of for example gels, granulated expanded clay, gravel, basalt, perlite, coconut fibre or mineral wool (rock wool).

The metal-P-compounds according to the invention can be used as such or in their formulations also mixed with substances known to the man skilled in the art, fungicides, bactericides, acaricides, nematicides or insecticides, also herbicides and so-called safeners (substances added to a plant protection agent so that it does not have a phytotoxic action). In many cases in that respect synergistic effects are achieved, that is to say the effectiveness of the mixture is greater than that of the individual components. The active substances are obvious to the man skilled in the art in plant protection and agricultural chemistry as mixture or application partners and are to be found in the literature (“Pesticide Manual”, 13th Ed 2003, The British Crop Protection Council, London; Ullmann's Agrochemicals, Vol 1 and 2; Wiley-VCH Verlag GmbH & Co KGaA, Weinheim, 2007).

The nutrient compositions according to the invention can be applied simultaneously, sequentially or in combination with other nutrient and active substances. Each nutrient substance can be applied separately as an individual component or in a mix with more than one mixture or application partner.

The nutrient compositions according to the invention can be applied directly, that is to say without containing further components and without being diluted. In certain embodiments the nutrient compositions are applied with other nutrient and active substances in the form of a suitable formulation or the form of application prepared therefrom by further dilution. Examples of formulations are as follows: water-soluble concentrates (SL, LS), dispersible concentrates (DC), emulsifiable concentrates (EC), emulsions (EW, EO, ES), suspensions (SC, OD, FS), water-dispersible and water-soluble granulates (WG, SG), water-dispersible and water-soluble powders (WP, SP, SS, WS), gel formulations (GF), dusts (DP, DS), granulates (GR, FG, GG, MG), ULV solutions (UL). Particularly for seed treatment use is made of water-soluble concentrates (LS), suspensions (FS), dusts (DS), water-dispersible or water-soluble powders (WS, SS), emulsions (ES), emulsifiable concentrates (EC) and gel formulations (GF), and, for further applications, active substance-impregnated natural and synthetic substances, encapsulations in polymer substances and in casing materials and as controlled release or slow release formulations. That list does not represent a limitation. The actual form of application depends on the respective purpose of use; in any event it is to ensure good uniform distribution of the compound according to the invention.

The formulations used can be produced in a manner known to the man skilled in the art, for example by mixing the nutrient substances, optionally with the addition of usual additives like for example fillers, carrier substances, diluting and/or dissolving agents, further using different kinds of surface-active agents, that is to say wetting, adhesive, dispersing or emulsifying agents and/or foam-generating agents. In accordance with the per se known manner of their manufacture the specified formulations may include further useful processing and formulation additives like organic or inorganic thickeners, stabilisers, gelling agents, evaporation accelerators, anti-foaming agents, adhesives, frost protection agents, siccatives, UV-stabilisers and possibly colouring agents and pigments as well as bactericides and frost protection agents etc. The formulation additives are if desired added to the compound in a ratio of 30:1 to 1:30.

The nutrient compositions according to the invention can be used by treating the plants to be fertilised, seeds, plant materials, materials or the ground with an effective amount of the nutrient compositions by pouring, dipping, spraying, sprinkling, misting, vapourising, injecting, silting over, spreading, dusting, scattering, dry dressing, moist dressing, wet dressing, slurry dressing or incrusting, or in the case of propagation material, in particular in the case of seeds and vegetative plant parts, further by coating with one or more layers, prior to or after sowing, or after setting the plants or prior to or after the plants emerge. The nutrient compositions can be applied at the same time jointly or separately or in succession.

The contents of the nutrient compositions of the forms of application prepared from the commercially usual formulations can vary within wide limits. The “effective amount” generally includes an agricultural-chemical, quantitative composition of the nutrient compositions, which economically enhances the yield on the basis of a nutrient-physiological fertiliser action. The “effective amount” can vary within a wide range and is determined by numerous factors like the weather conditions and the climate, the growth stage of the cultivation or the pathogenic parasite pressure. Accordingly the “effective amount” may not be limited by definition. Nonetheless the following items may be set out:

When using the nutrient compositions according to the invention the amounts used can be varied depending on the respective kind of application within a relatively large range. In the treatment of agricultural areas the amounts of nutrient composition used can generally be between 10 and 50,000 g/ha, preferably between 100 and 25,000 g/ha, in particular between 250 and 10,000 g/ha. In seed treatment the amounts of nutrient compositions used can generally be between 0.001 and 100 g per kilogram of seed material, preferably between 0.01 and 50 g per kilogram of seed material, in particular between 0.1 and 25 g per kilogram of seed material.

Oils of various types, adhesive agents, wetting agents, surfactants, adjuvants (additive substances), herbicides, fungicides, other anti-pest agents, and bactericides can also be added to the nutrient compositions, possibly only directly before application (tank mix).

According to the invention all plants and plant pieces can be treated with the nutrient compositions. The term plants is used here to denote all plants and plant populations like wanted and unwanted wild plants or cultivated plants (including naturally occurring crop plants). Crop plants can be plants which can be produced by conventional cultivation and optimisation methods or by biotechnological and genetic engineering methods or combinations of such methods, including transgenic plants (obtained by genetic engineering) and including the plant varieties which can be protected or which cannot be protected by variety property rights. The term plant pieces is used to denote all above-ground and underground parts and organs of the plants such as shoot, leaf, flower and root, in which respect leaves, needles, stalks, stems, flowers, fruit bodies, fruits and seeds as well as roots, tubers and rhizomes are listed by way of example. The plant parts also include crop material and vegetative and generative propagation material, for example cuttings, tubers, rhizomes, grafts and seeds. Important cultivated plants like cereals (wheat, rice), corn, soya, potato, cotton and oil seed rape are particularly emphasised as examples of transgenic plants.

The nutrient compositions can be of particular significance for the fertilisation of a large number of cultivated plants and crops like cereals (wheat, barley, rye, triticale, oats, rice, sorghum), beet (sugar beet and mangold), pome, stone and soft fruit (apples, pears, plums, peaches, almonds, cherries, raspberries, blackberries, cranberries, redcurrants, gooseberries or strawberries), legumes (peas, beans, lentils, soya beans), oil crops (mustard, rape, poppy, olives, sunflowers, flax, coconut, oil palm, castor, cocoa, peanuts), cucumber plants (cucumbers, melons, pumpkins), fibre plants (cotton, flax, hemp and jute), citrus fruits (oranges, lemons, mandarins, grapefruit), vegetable crops (types of cabbage and lettuce, asparagus, spinach, carrots, onions, potatoes, tomatoes and peppers), lauraceae (avocados, cinnamon or camphor), further plants like bananas, corn, vines, sugar cane, nuts, coffee, tea, tobacco, hops, also energy and raw-material plants like for example corn, soya bean, wheat, rape, sugar beet, sugar cane, oil palm or poplar and willow trees and also ornamental and forestry plants (annual and perennial shrubs, conifers, composites, bushes and trees) and grass as a lawn and on the propagation material, for example seed and the crop of such plants. This list does not represent any limitation.

### 8. EMBODIMENTS BY WAY OF EXAMPLE AND FIGURES

The mixed-metallic crystalline orthophosphates used according to the invention differ in particular in their individual water and acid solubility. By a specific combination of the main elements including the elements Mn, Mg and/or Ca and by adding given doping metals, a given ratio of the metals to each other is set, which leads to the individual water and acid solubility properties, as are shown in accompanying Figures.

In the drawings:

FIG. 1 shows the results of solubility experiments with (FeMg)₃(PO₄)₂*3H₂O,

FIG. 2 shows the results of solubility experiments with (FeMgMnCuZn)₃(PO₄)₂,

FIG. 3 shows the results of solubility experiments with (FeMn)₃(PO₄)₂,

FIG. 4 shows the results of solubility experiments with (FeMnMgCuZnMoB)₃(PO₄)₂,

FIG. 5 shows the results of solubility experiments with NH₄(FeMg)₃(PO₄)₂,

FIG. 6 shows the results of solubility experiments with NH₄(FeMnMg)₃(PO₄)₂ and

FIG. 7 shows the results of solubility experiments with NH₄(FeMnMg)₃(PO₄)₂

FIG. 8 shows XRD diffractograms of (Fe_{0.41}Mg_{0.33}Mn_{0.10}Zn_{0.06})₃(PO₄)₂.3H₂O and NH₄(Fe_{0.55}Mg_{0.45})PO₄.3H₂O.

The solubility experiments were performed in 1 mmol (“rhombus”), 5 mmol (“square”) of citric acid and in some experiments also in water (“triangle”) over a relatively long fixedly defined period of time (in hours).

For that purpose in each case 0.03 g of the respective crystalline orthophosphate was suspended in 30 ml of the respective test liquid (distilled H₂O, 1 mmol/l citric acid and 5 mmol/l citric acid). The suspension was continuously circulated at 25° C. for a period of 24 h on a tumbler mixer (VWR Nutating Mixer; ECN: 444-0148) (circling+tipping shaking movement) and then centrifuged to separate the solid residues from the liquid phase. The proportion of the dissolved elements P, Fe, Mg, Mn, Cu, Zn, Mo and B in the liquid phase was determined by means of ICP-OES. The ammonium content was determined by way of a Hach-Lange cuvette test (LCK test, photometrically). The remaining residue was mixed again with 30 ml of the respective test liquid and continuously circulated on the tumbler mixer until the next analysis moment. A saturation effect in respect of the dissolved constituents in the solvent is avoided in that way.

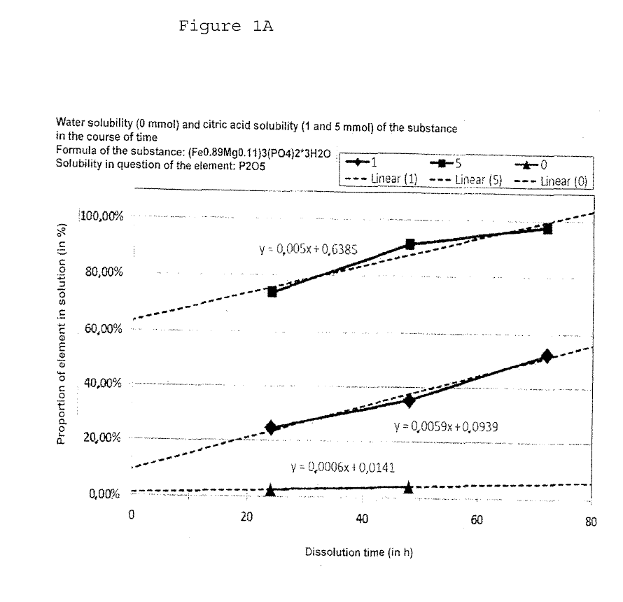

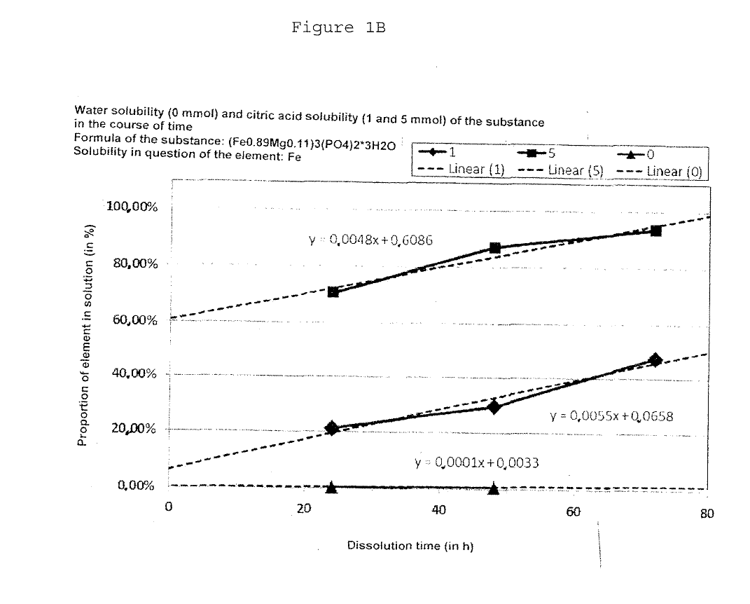

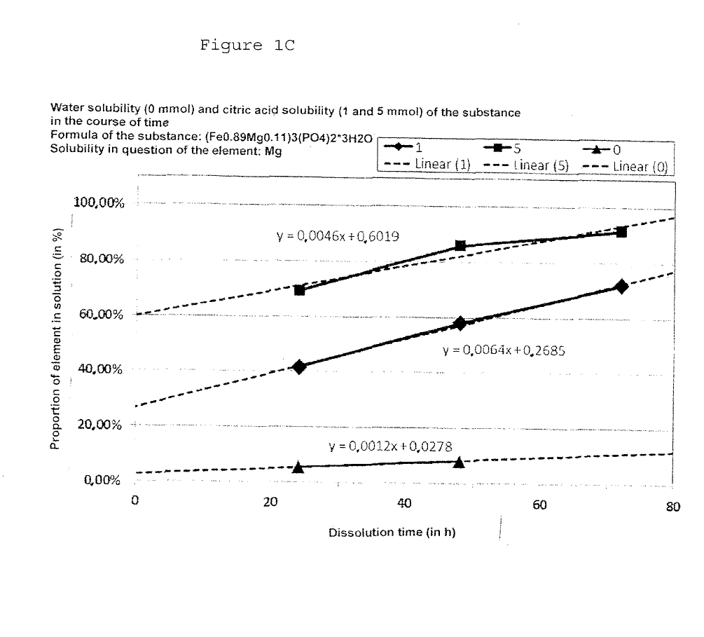

FIG. 1 shows the results of solubility experiments with a mixed-metallic crystalline orthophosphate according to the invention of the type (FeMg)₃(PO₄)₂*3H₂O with the specific formula (Fe_{0.89}Mg_{0.11})₃(PO₄)₂*3H₂O), wherein the specific formula for the mixed-metallic crystalline orthophosphate specifies the molar ratio of iron to magnesium of 89:11. More specifically FIG. 1 shows the variations in respect of time of the solubility of the ions P₂O₅, Fe and Mg contained in the compound.

It can be deduced from the results shown in FIG. 1 that the proportion here of Mg leads to good solubility of the ions contained in the mixed-metallic crystalline orthophosphate according to the invention in 1 mmol citric acid solution and very good solubility of the ions in 5 mmol citric acid solution, wherein water solubility of the ions remains negligible.

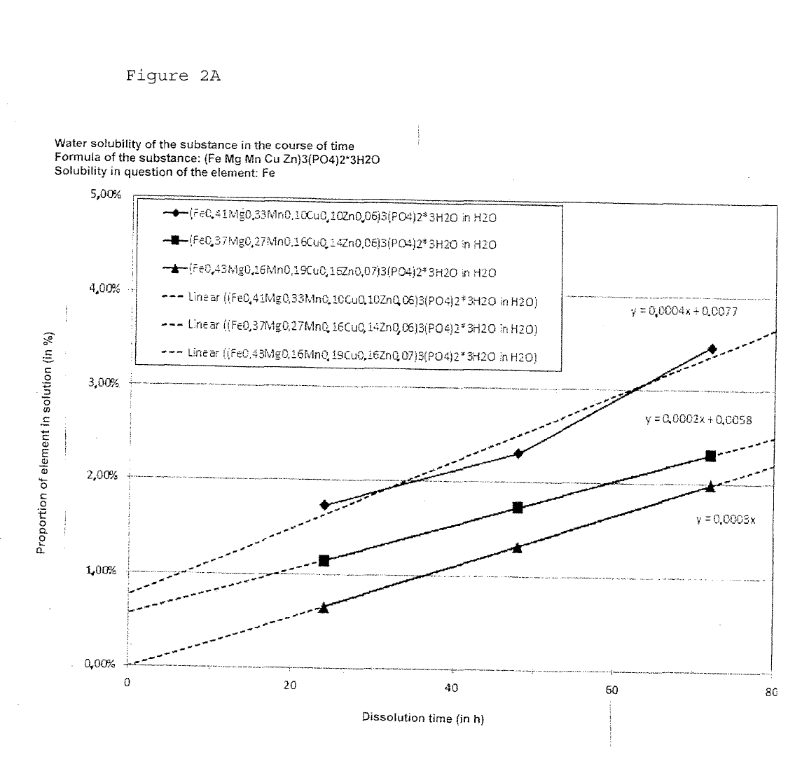

FIG. 2 shows the results of solubility experiments with various mixed-metallic crystalline orthophosphates according to the invention of the type (FeMgMnCuZn)₃(PO₄)₂*3H₂O, wherein the molar ratio of the metals contained in the respective mixed-metallic crystalline orthophosphate varies as shown in detail in FIG. 2. For the various mixed-metallic crystalline orthophosphates according to the invention of the type (FeMgMnCuZn)₃(PO₄)₂*3H₂O, FIG. 2 shows the variation in respect of time of the solubility on the basis of the Fe-ions in water on the one hand and in 1 mmol citric acid solution on the other hand.

It can be deduced from the results shown in FIG. 2 that there is a direct relationship between the increase in the proportions of the metals Mn and/or Mg and the increase in solubility of the ions contained in the mixed-metallic crystalline orthophosphate according to the invention, wherein the best solubility is achieved with particularly high proportions of Mg.

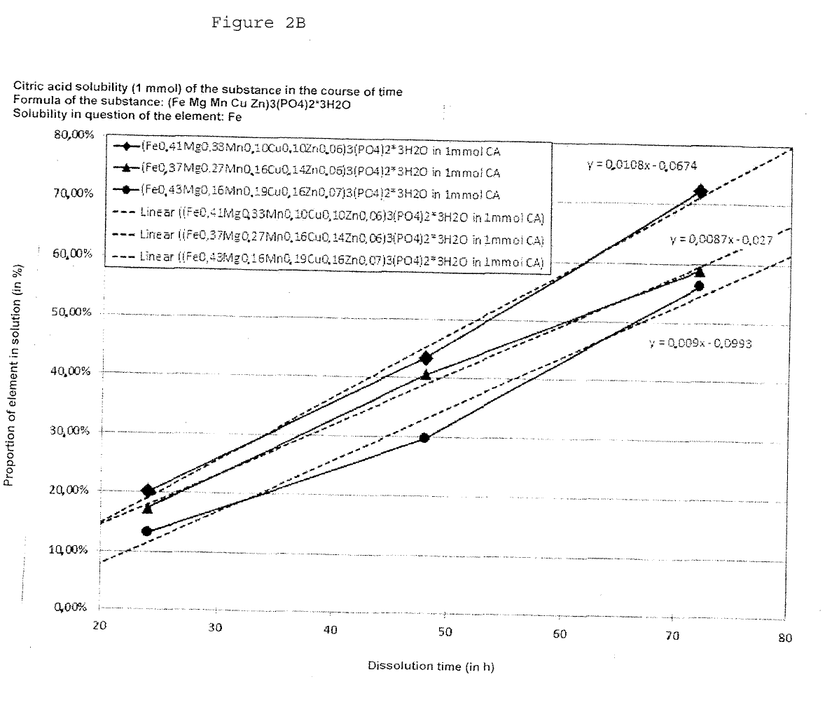

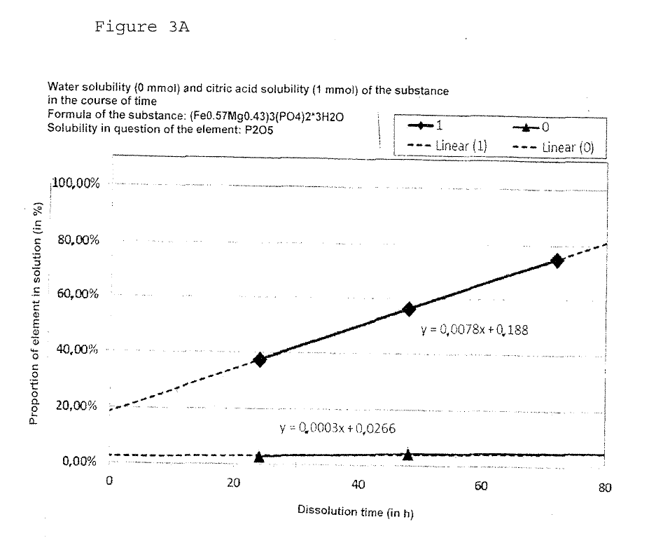

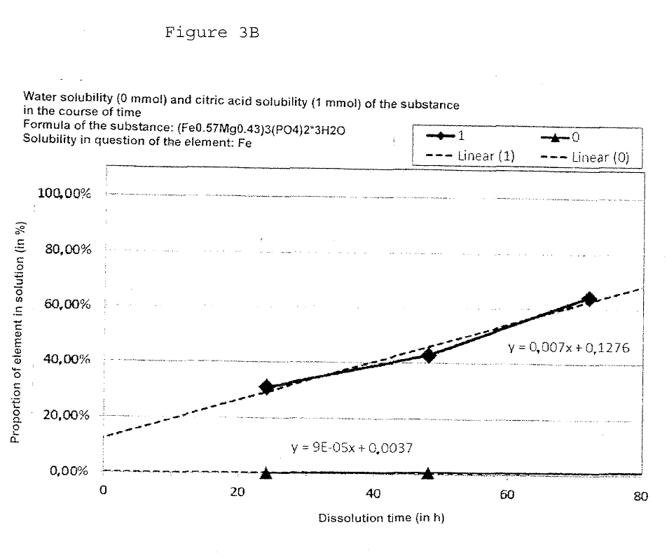

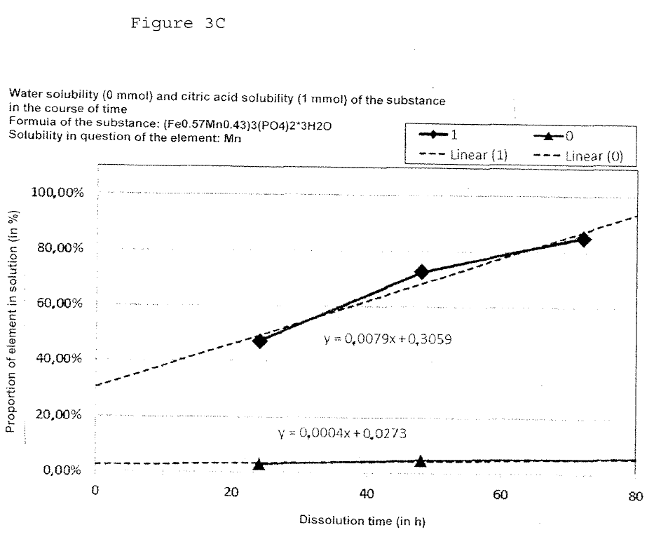

FIG. 3 shows the results of solubility experiments with a mixed-metallic crystalline orthophosphate according to the invention of the type (FeMn)₃(PO₄)₂*3H₂O with the specific formula (Fe_{0.57}Mn_{0.43})₃(PO₄)₂*3H₂O, wherein the specific formula for that mixed-metallic crystalline orthophosphate specifies the molar ratio of iron to magnesium of 57:43. FIG. 3 in detail shows the variations in respect of time of the solubility of the ions P₂O₅, Fe and Mg contained in the compound.

It can be deduced from the results shown in FIG. 3 that the proportion here of Mn leads to good solubility of the ions contained in the mixed-metallic crystalline orthophosphate according to the invention in 1 mmol citric acid solution, the water solubility of the ions remaining negligible.

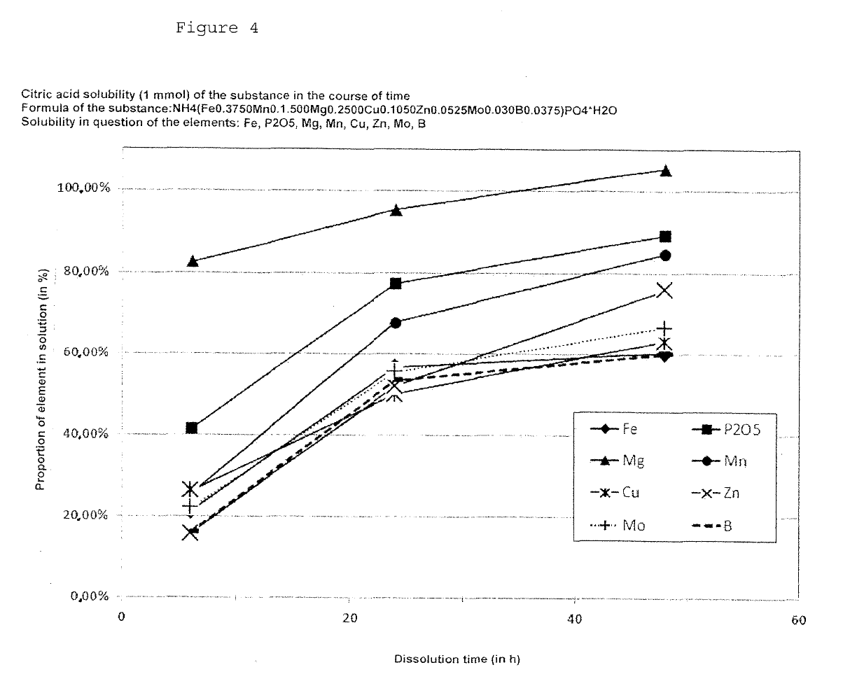

FIG. 4 shows the results of solubility experiments with a mixed-metallic crystalline orthophosphate according to the invention of the type NH₄(FeMnMgCuZnMoB)₃(PO₄)₂*H₂O with the specific formula NH₄(Fe_{0.375}Mn_{0.15}Mg_{0.25}Cu_{0.105}Zn_{0.0525}Mo_{0.03}B_{0.0375})₃(PO₄)₂*H₂O, wherein the molar ratio of the metals contained in the respective mixed-metallic crystalline orthophosphate is represented by the values shown in the formula. FIG. 4, for that mixed-metallic crystalline orthophosphate, shows the variation in respect of time of the ions P₂O₅, Fe, Mg, Mn, Cu, Zn, Mo and B contained in the compound.

It can be deduced from the results shown in FIG. 4 that the proportions here of Mg and Mn lead to good solubility of the ions contained in the mixed-metallic crystalline orthophosphate according to the invention in 1 mmol citric acid solution.

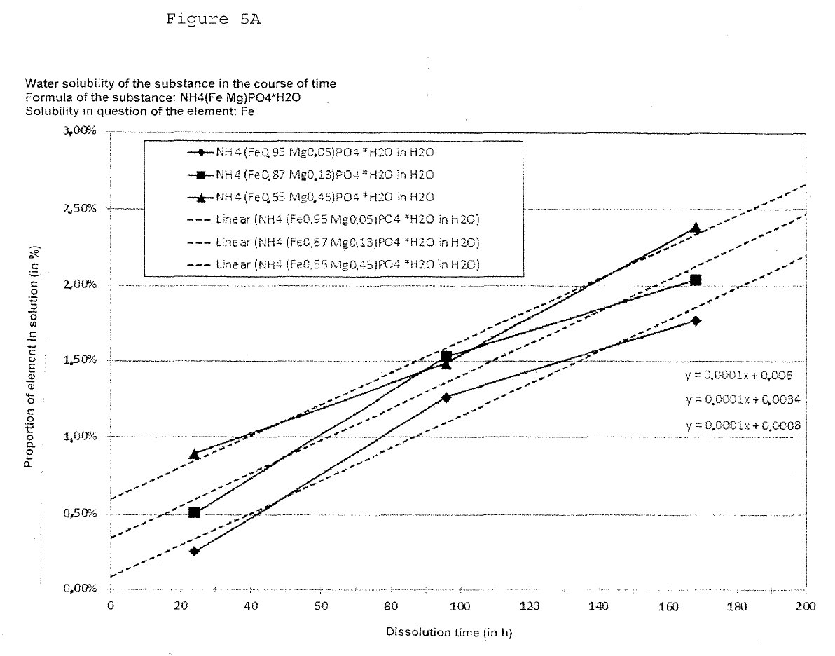

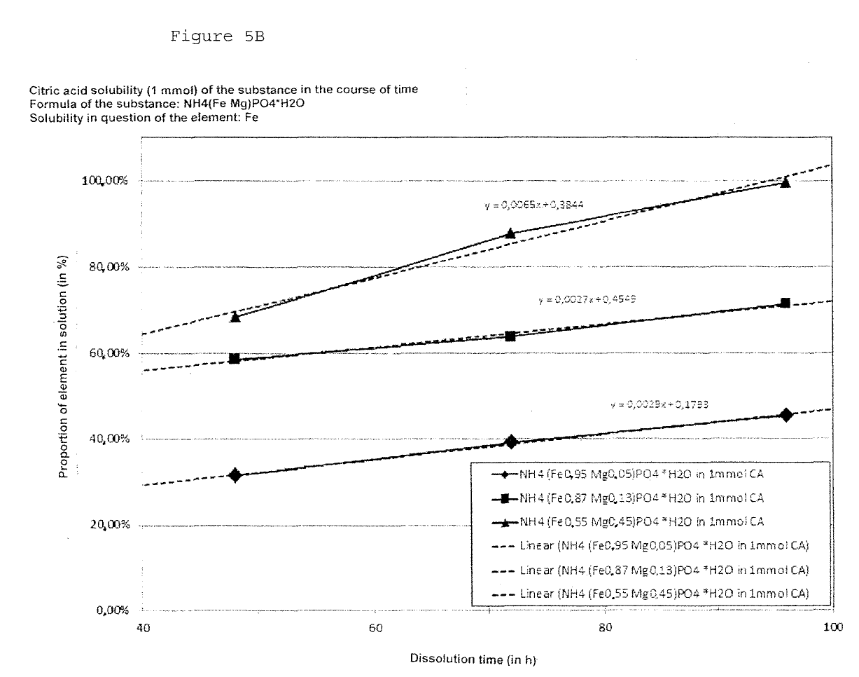

FIG. 5 shows the results of solubility experiments with various mixed-metallic crystalline orthophosphates according to the invention of the type NH₄(FeMg)(PO₄)*H₂O, wherein the molar ratio of the metals contained in the respective mixed-metallic crystalline orthophosphate varies as shown in detail in FIG. 5. FIG. 5, for the various mixed-metallic crystalline orthophosphates of the type NH₄(FeMg)(PO₄)*H₂O according to the invention shows the variation in respect of time of the solubility on the basis of the Fe-ions in water on the one hand and in 1 mmol citric acid solution on the other hand.

It can be deduced from the results shown in FIG. 5 that there is a direct relationship between the increase in the proportions of Mg and the increase in the solubility of the ions contained in the mixed-metallic crystalline orthophosphate according to the invention, wherein the described effect is already achieved with a really small proportion of Mg.

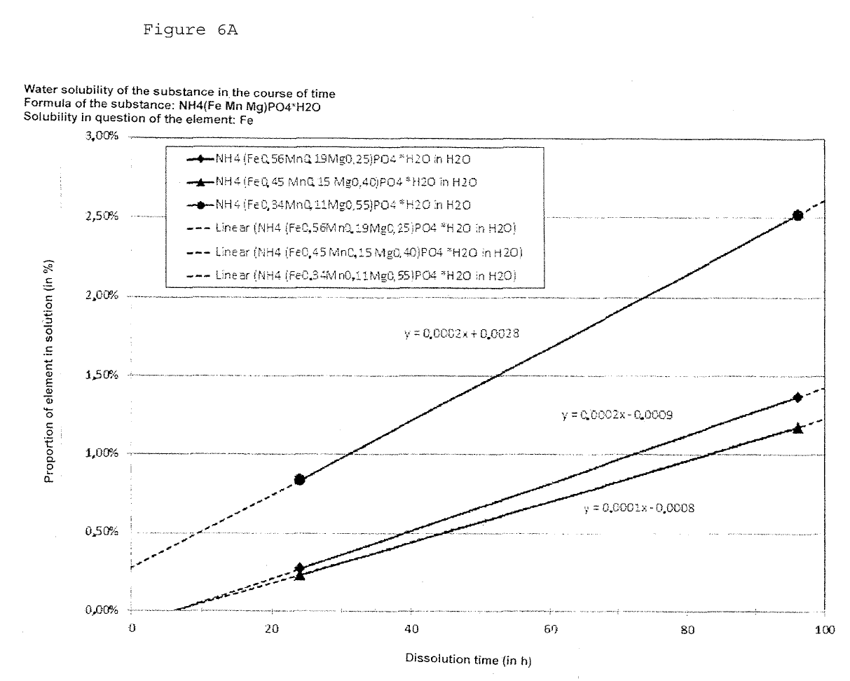

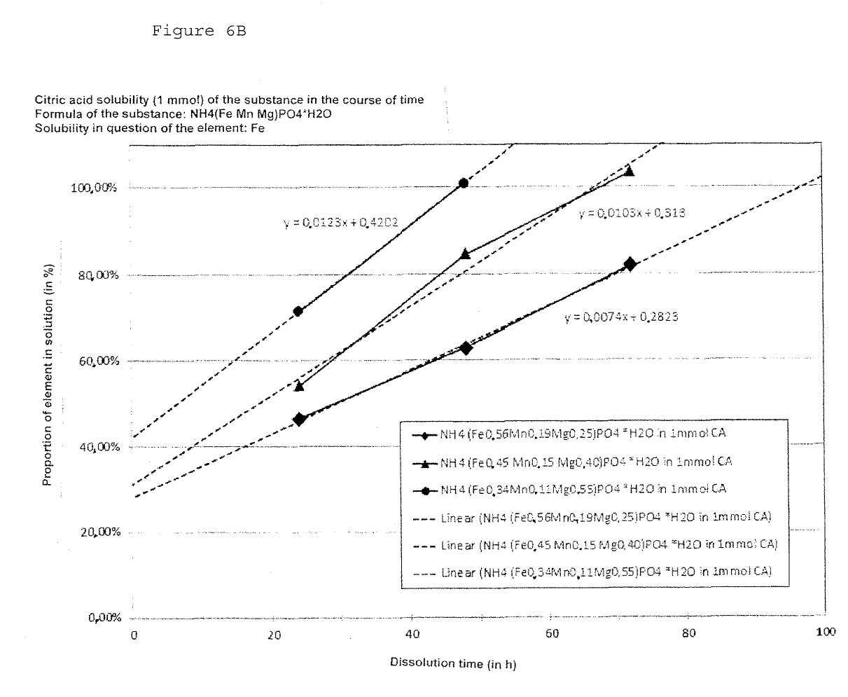

FIG. 6 shows the results of solubility experiments with various mixed-metallic crystalline orthophosphates according to the invention of the type NH₄(FeMnMg)(PO)₄, wherein the molar ratio of the metals contained in the respective mixed-metallic crystalline orthophosphate varies as shown in detail in FIG. 6. FIG. 6, for the various mixed-metallic crystalline orthophosphates of the type NH₄(FeMnMg)(PO₄)*H₂O according to the invention shows the variation in respect of time of the solubility on the basis of the Fe-ions in water on the one hand and in 1 mmol citric acid solution on the other hand.

It can be deduced from the results shown in FIG. 6 that there is a direct relationship between the increase in the proportions of the metals Mn and/or Mg and the increase in the solubility of the ions contained in the mixed-metallic crystalline orthophosphate according to the invention, wherein the best solubility is achieved with particularly high proportions of Mg.

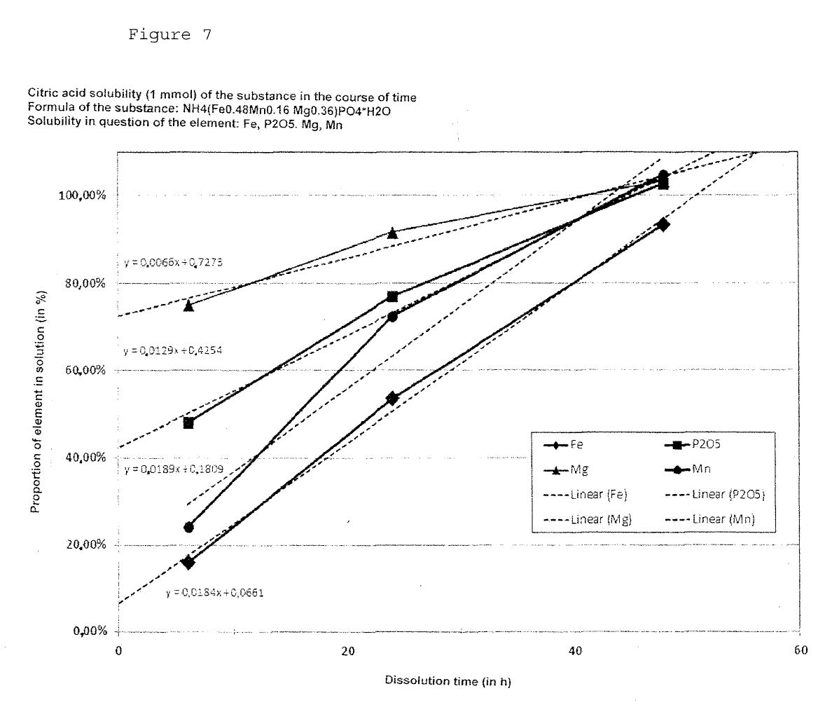

FIG. 7 shows the results of solubility experiments with a mixed-metallic crystalline orthophosphate according to the invention of the type NH₄(FeMnMg)(PO)₄ with the specific formula NH₄Fe_{0.48}Mn_{0.16}Mg_{0.36}PO₄)*H₂O, wherein the molar ratio of the metals contained in the respective mixed-metallic crystalline orthophosphate is represented by the values specified in the formula. For that mixed-metallic crystalline orthophosphate FIG. 7 shows the variation in respect of time of the ions P₂O₅, Fe, Mg and Mn contained in the compound.

It can be deduced from the results shown in FIG. 7 that the proportions here of Mg and Mn lead to good solubility of the ions contained in the mixed-metallic crystalline orthophosphate according to the invention in 1 mmol citric acid solution.

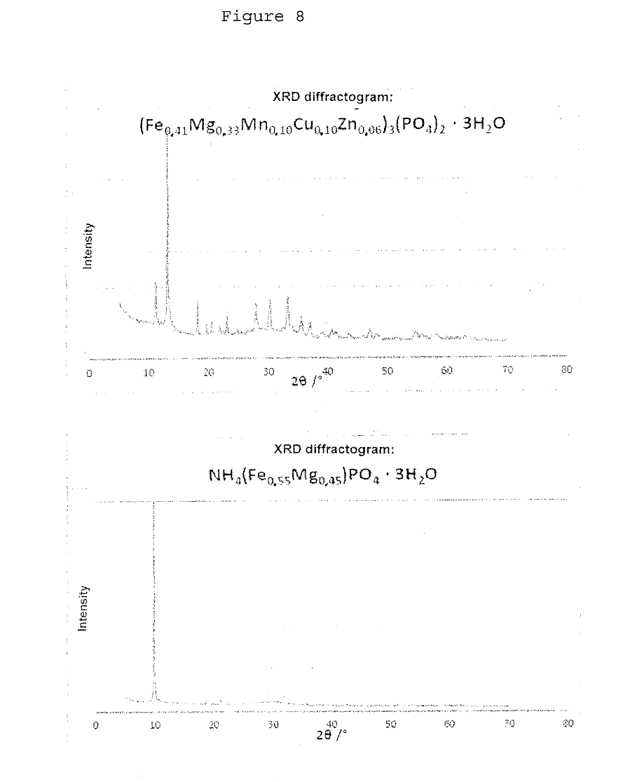

FIG. 8 shows the XRD diffractograms of two mixed-metallic crystalline orthophosphates according to the invention. The upper diffractogram originates from a mixed-metallic crystalline orthophosphate according to the invention of the type FeMgMnCuZn)₃(PO₄)₂ with the specific formula (Fe_{0.41}M_{0.0.33}Mn_{0.10}Cu_{0.10}Zn_{0.06})₃(PO₄)₂.3H₂O, and the lower diffractogram originates from a mixed-metallic crystalline orthophosphate according to the invention of the type NH₄(FeMg)PO₄.3H₂O with the specific formula NH₄(Fe_{0.55}Mg_{0.45})PO₄. 3H₂O.

1. A nutrient composition for plants which contains at least one mixed-metallic crystalline orthophosphate of the type [Tₐ(M1 M2 M3 . . . Mx)_{b}(PO₄)_{c}.nH₂O], wherein
T is selected from NH₄, K or CH₄N₂O,
M1, M2, M3 . . . Mx are metals selected from Mg, Ca, Mn, Fe, Co, Ni, Cu and Zn,
a=0 or 1, wherein
b=3 when a=0 and b=1 when a=1 and wherein
c=2 when a=0 and c=1 when a=1and wherein
0≦n≦9,
wherein the mixed-metallic crystalline orthophosphate contains at least two different metals M1, M2, M3 . . . Mx, with the proviso that at least one of said at least two different metals is selected from Mn, Mg and Ca, wherein the total proportion of Mn, Mg and/or Ca in total is in the region of 0.5 to 90 mol-% with respect to the total amount of all metals contained in the mixed-metallic crystalline orthophosphate.

2. The nutrient composition according to claim 1, wherein within a period of up to 50 hours at most 10 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer.

3. The nutrient composition according to claim 1, wherein within a period of up to 100 hours at most 20 wt-% of each of the metals contained in the mixed-metallic crystalline orthophosphate pass into solution if 0.03 g of the mixed-metallic crystalline orthophosphate is continuously circulated in 30 ml of water at 25° C. on a tumbler mixer.

4. The nutrient composition according to claim 1, wherein within a period of up to 50 hours at least 25 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer.

5. The nutrient composition according to claim 1, wherein within a period of up to 100 hours at least 35 wt-% of each of the metals contained in the mixed-metallic crystalline orthophosphate pass into solution if 0.03 g of the mixed-metallic crystalline orthophosphate is continuously circulated in 30 ml of 1 mmol citric acid solution at 25° C. on a tumbler mixer.

6. The nutrient composition according to claim 1, wherein within a period of up to 50 hours at least 75 wt-% of each of the metals contained in the mixed-metallic crystalline orthophosphate pass into solution if 0.03 g of the mixed-metallic crystalline orthophosphate is continuously circulated in 30 ml of 5 mmol citric acid solution at 25° C. on a tumbler mixer.

7. The nutrient composition according to claim 1, wherein the total proportion of Mn, Mg and/or Ca in total is in the region of 2.5 to 80 mol-%, preferably in the region of 5 to 75 mol-% with respect to the total amount of all metals contained in the mixed-metallic crystalline orthophosphate.

8. The nutrient composition according to claim 1, wherein the at least one mixed-metallic crystalline orthophosphate is of the type [(M1, M2, M3 . . . Mx)₃(PO₄)₂.nH₂O], wherein M1, M2, M3 . . . Mx are selected from Mg, Ca, Mn, Fe, Co, Ni, Cu and Zn, and wherein 0≦n≦9.

9. The nutrient composition according to claim 1, wherein the at least one mixed-metallic crystalline orthophosphate is of the type [T (M1, M2, M3 . . . Mx)(PO₄).nH₂O], wherein T is selected from NH₄, K or CH₄N₂O, wherein M1, M2, M3 . . . Mx are selected from Mg, Ca, Mn, Fe, Co, Ni, Cu and Zn, and wherein n≦1.

10. The nutrient composition according to claim 1, wherein in addition to the at least one mixed-metallic crystalline orthophosphate the nutrient composition contains further additives which are selected from macronutrients, micronutrients, multi-nutrient fertilisers, organic fertilisers, plant enhancers, chelating and complexing substances or ground structure improving agents as well as peat cultivation substrates, peat-free earths and standard soils or substrates with peat and clay.

11. The nutrient composition according to claim 1, wherein the nutrient composition is in the form of a suspension, a powdered fertiliser, a granulated fertiliser, in the form of an enhanced efficiency fertiliser or in the form of a storage fertiliser with defined slow nutrient release.

12. A method comprising time-controlled of releasing Mg, Ca, Mn, Fe, Co, Ni, Cu and/or Zn in the rhizodermal region of plants by using the nutrient composition according to claim 1.

13. A method comprising time-controlled releasing Mg, Ca, Mn, Fe, Co, Ni, Cu and/or Zn in the epidermal region of plants by using the nutrient composition according to claim 1.

14. A method of fertilising plants, comprising making available the nutrient composition according to claim 1 in the rhizodermal region of the plants.

15. A method of fertilising plants, comprising making available the nutrient composition according to claim 1 in the epidermal region of the plants.

16. The method of fertilising plants according to claim 14, wherein, in the method, the solubility of the at least one mixed-metallic crystalline orthophosphate contained in the nutrient composition in water, in 1 mmol citric acid solution and/or in 5 mmol citric acid solution is so selected that the metals Mg, Ca, Mn, Fe, Co, Ni, Cu and/or Zn contained in the at least one mixed-metallic crystalline orthophosphate are released in time-controlled manner in the amount required for the respective plant and the given conditions.
